(19) United States
(12) Patent Application Publication
(10) Pub. No.: US 2018/0259346 A1
(43) Pub. Date: Sep. 13, 2018

(54) VEHICLE DISPLAY DEVICE, DISPLAY METHOD AND DISPLAY PROGRAM

(71) Applicant: JVC KENWOOD Corporation, Yokohama-shi (JP)

(72) Inventor: Noboru Katsumata, Yokohama-shi (JP)

(21) Appl. No.: 15/978,298

(22) Filed: May 14, 2018

Related U.S. Application Data
(63) Continuation of application No. PCT/JP2016/079691, filed on Oct. 5, 2016.

(30) Foreign Application Priority Data
Dec. 21, 2015 (JP) 2015-248186
Aug. 24, 2016 (JP) 2016-164150

(51) Int. Cl. G01C 21/26; G06F 3/0481; H04N 7/18; G01C 21/20

(52) U.S. Cl. CPC G01C 21/265; G01C 21/20; H04N 7/18; G06F 3/0481

(57) ABSTRACT

A vehicle display device includes a video acquisition unit configured to acquire videos obtained by imaging the surroundings of a vehicle; a bird's-eye view video generator configured to generate a bird's-eye view video that is obtained by performing viewpoint conversion on the videos acquired by the video acquisition unit to realize a view from above the vehicle and synthesizing a virtual vehicle video representing a positon of the vehicle; an object specifying unit configured to specify a direction-indicated object as a specified object; a positional information acquisition unit configured to acquire positional information about the specified object; a vehicle information acquisition unit configured to acquire a current position and a travel direction of the vehicle; a direction specifying unit configured to specify a direction of the specified object radially from the vehicle; and a display controller.

### CROSS-REFERENCE TO RELATED APPLICATION(S)

This application is a continuation of PCT international application Ser. No. PCT/JP2016/079691, filed on Oct. 5, 2016 which designates the United States, incorporated herein by reference, and which claims the benefit of priority from Japanese Patent Application No. 2015-248186, filed on Dec. 21, 2015 and Japanese Patent Application No. 2016-164150, filed on Aug. 24, 2016, incorporated herein by reference.

### BACKGROUND OF THE INVENTION

### 1. Field of the Invention

The present invention relates to a vehicle display device, a display method and a display program.

### 2. Description of the Related Art

Car navigation devices include one with a function of displaying landmarks serving as signs during a travel on a map. Facilities, such as gas stations, can be displayed as the landmarks. The car navigation device displays marks corresponding to landmarks in the positions of facilities on the displayed map that are on the route in which a vehicle is traveling. By displaying the landmarks, the car navigation device enables a user to compare the marks displayed on the map with the facilities actually viewed from the vehicle and easily check the current position of the vehicle, crossroads where the vehicle turns right or left, etc.

Japanese Unexamined Patent Application Publication No. 2004-226139 A describes a technology of using a given landmark whose position can be checked even from a distance and displaying, on a map, a direction in which the landmark is viewed.

The technology described in Japanese Unexamined Patent Application Publication No. 2004-226139 A makes it possible to know the positional relationship between a vehicle and a landmark serving as a subject on the map; however, it is not clear in which direction the subject landmark is with respect to the vehicle in which the user actually is.

### SUMMARY OF THE INVENTION

It is an object of the present invention to at least partially solve the problems in the conventional technology.

A vehicle display device according to one aspect includes a video acquisition unit configured to acquire videos obtained by imaging the surroundings of a vehicle, a bird's-eye view video generator configured to generate a bird's-eye view video that is obtained by performing viewpoint conversion on the videos acquired by the video acquisition unit to realize a view from above the vehicle and synthesizing a virtual vehicle video representing a positon of the vehicle, an object specifying unit configured to specify a direction-indicated object as a specified object, a positional information acquisition unit configured to acquire positional information about the specified object, a vehicle information acquisition unit configured to acquire a current position and a travel direction of the vehicle, a direction specifying unit configured to specify a direction of the specified object radially from the vehicle on the basis of the current position, the travel direction, and the positional information about the specified object, and a display controller configured to add an icon representing the specified object in the direction specified by the direction specifying unit to the bird's-eye view video and cause a display unit to display the bird's-eye view video added with the icon.

A display method according to one aspect includes acquiring videos obtained by imaging the surroundings of a vehicle, generating a bird's-eye view video that is obtained by performing viewpoint conversion on the acquired videos to realize a view from above the vehicle and synthesizing a virtual vehicle video representing a positon of the vehicle, specifying a direction-indicated object as a specified object, acquiring positional information about the specified object, acquiring a current position and a travel direction of the vehicle, specifying a direction of the specified object radially from the vehicle on the basis of the current position, the travel direction, and the positional information about the specified object, and adding an icon representing the specified object in the specified direction to the bird's-eye view video and displaying the bird's-eye view video added with the icon.

A non-transitory computer readable recording medium storing therein a display program according to one aspect causes a computer that operates as a vehicle display device to function as a unit configured to generate a bird's-eye view video that is obtained by performing viewpoint conversion on videos acquired by imaging surroundings of a vehicle to realize a view from above the vehicle and synthesizing a virtual vehicle video representing a positon of the vehicle, a unit configured to specify a direction-indicated object as a specified object, a unit configured to acquire positional information about the specified object, a unit configured to acquire a current position and a travel direction of the vehicle, a unit configured to specify a direction of the specified object radially from the vehicle on the basis of the current position, the travel direction, and the positional information about the specified object, and a unit configured to add an icon representing the specified object in the specified direction to the bird's-eye view video and display the bird's-eye view video added with the icon.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary functional configuration of a vehicle display device according to a first embodiment;

FIG. 2 is a diagram illustrating exemplary display of a bird's-eye view video that is performed by a display unit;

FIG. 3 is a diagram illustrating other exemplary display of a bird's-eye view video that is performed by the display unit;

FIG. 4 is a flowchart illustrating an exemplary display method of the vehicle display device according to the first embodiment;

FIG. 5 is a diagram illustrating an exemplary functional configuration of a vehicle display device according to a second embodiment;

FIG. 6 is a flowchart illustrating an exemplary display method of the vehicle display device according to the second embodiment;

FIG. 7 is a diagram illustrating a modification of the bird's-eye view video;

FIG. 8 is a diagram illustrating a modification of the bird's-eye view video;

FIG. 9 is a diagram illustrating exemplary display of a bird's-eye view video that is performed by the display unit;

FIG. 10 is a diagram illustrating exemplary display of a bird's-eye view video that is performed by the display unit;

FIG. 11 is a diagram illustrating an exemplary functional configuration of a vehicle display device according to a third embodiment;

FIG. 12 is a diagram illustrating exemplary display of a bird's-eye view video that is performed by the display unit;

FIG. 13 is a flowchart illustrating an exemplary display method of the vehicle display device according to the third embodiment;

FIG. 14 is a flowchart illustrating an exemplary display method of a vehicle display device according to a fourth embodiment;

FIG. 15 is a flowchart illustrating an exemplary method of specifying the exit of a car park in the flowchart in FIG. 14;

FIG. 16 is a diagram illustrating a modification of the display of a bird's-eye view video that is performed by the display unit;

FIG. 17 is a flowchart illustrating a modification of the method of specifying the exit of a car park in the flowchart in FIG. 14 in the display method of the vehicle display device according to the fourth embodiment;

FIG. 18 is a diagram illustrating an exemplary functional configuration of a vehicle display device according to a fifth embodiment;

FIG. 19 is a diagram illustrating exemplary display of a bird's-eye view video that is performed by the display unit;

FIG. 20 is a flowchart illustrating an exemplary display method of the vehicle display device according to the fifth embodiment;

FIG. 21 is a diagram illustrating a modification of the display of a bird's-eye view video that is performed by the display unit; and

FIG. 22 is a flowchart illustrating a modification of the display method of the vehicle display device according to the fifth embodiment.

### DETAILED DESCRIPTION OF THE PREFERRED EMBODIMENTS

With reference to the drawings, embodiments of the vehicle display device according to the present invention will be described in detail below. Note that the embodiments do not limit the invention. The components of the embodiments include ones that is replaceable and obvious to be replaced therewith whereas maintaining identical to the invention.

The multiple modifications described in the embodiments may be combined optionally within the scope obvious to those skilled in the art.

### First Embodiment

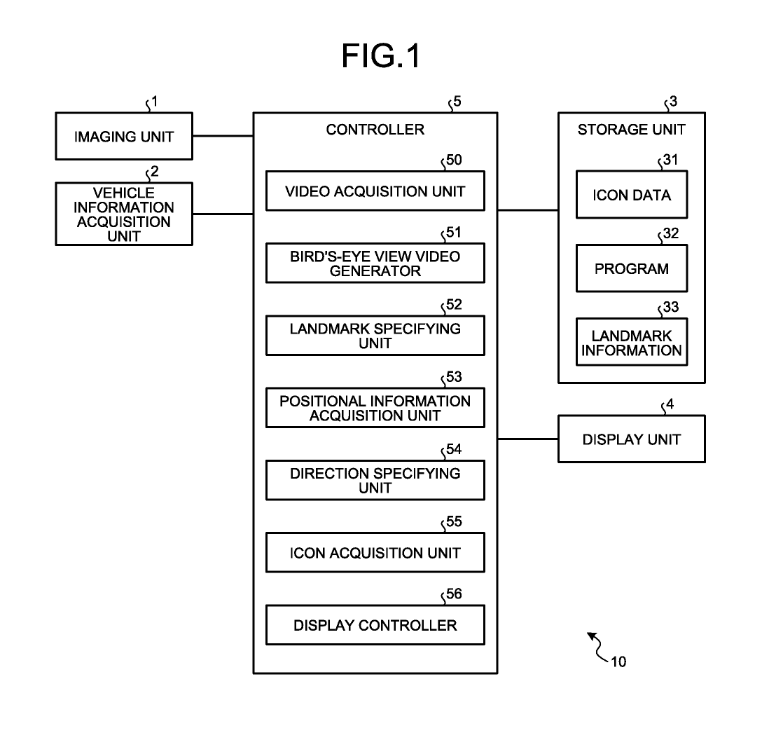

FIG. 1 is a diagram illustrating an exemplary functional configuration of a vehicle display device according to a first embodiment. As illustrated in FIG. 1, a vehicle display device 10 according to the first embodiment is realized by a function of the controller 5. The vehicle display device 10 may include an imaging unit 1, a vehicle information acquisition unit 2, a storage unit 3 and a display unit 4. The vehicle display device 10 is a device usable in a vehicle, and the vehicle display device 10 may be any one of a fixed one and a portable one.

The imaging unit 1 images the surroundings of the vehicle and acquires a video. The imaging unit 1 images, for example, an area of few meters from the vehicle and acquires videos. The imaging unit 1 includes cameras that are provided on the vehicle. The imaging unit 1, for example, acquires videos of the front, rear, left and right sides of the vehicle. The imaging unit 1 outputs data of the captured videos to a video acquisition unit 50, which will be described below.

The vehicle information acquisition unit 2 acquires information of the current position of the vehicle and information representing the direction in which the vehicle travels. The vehicle information acquisition unit 2 is, for example, a global positioning system (GPS) receiver and acquires the current position of the vehicle from the received information. The vehicle information acquisition unit 2 calculates the direction in which the vehicle travels on the basis of a position of the vehicle acquired before and the current position of the vehicle. Calculation of the travel direction performed by the vehicle information acquisition unit 2 may be replaced with calculation from the acquired current position information performed by the controller 5. A navigation device may be used for the vehicle information acquisition unit 2.

The storage unit 3 stores icon data 31. The icon data 31 is data for displaying icons corresponding to landmarks on the display unit 4. The icon data 31 may be data unique to each landmark or common icon data with respect to each category, such as towers, buildings or mountains. The storage unit 3 stores a program 32 to be executed by the controller 5. The storage unit 3 may be realized by a semiconductor memory or a hard disk device. The storage unit 3 stores positional information and height information about landmarks as landmark information 33. The vehicle display device 10 may include the storage unit 3 or a mode may be employed where another device includes the storage unit 3 and the vehicle display device 10 is able to refer to the data in a wired or wireless manner. The storage unit 3 may store geographic information.

The display unit 4 displays data that is output from the controller 5. The display unit 4 is, for example, realized by a liquid crystal display. The display unit 4 may be a display unit dedicated to the vehicle display device 10 or may be one for which the monitor of a navigation device is used.

The controller 5 includes the video acquisition unit 50, a bird's-eye view video generator 51, a landmark specifying unit 52, a positional information acquisition unit 53, a direction specifying unit 54, an icon acquisition unit 55, and a display controller 56. Each of the components may be realized by the controller 5 that is, for example, a central processing unit (CPU) by executing the program.

The video acquisition unit 50 acquires the videos captured by the imaging unit 1. The video acquisition unit 50 may performs a process of cutting out an area to be used as a bird's-eye view video from the video data acquired from the imaging unit 1.

The bird's-eye view video generator 51 generates a bird's-eye view video based on the videos of the surroundings of the vehicle that are acquired by the video acquisition unit 50. The bird's-eye view video is a top-view video of the vehicle. The bird's-eye view video generator 51 generate a bird's-eye view video by performing viewpoint conversion on the videos of the surroundings of the vehicle to realize a view from above the vehicle and synthesizing a virtual vehicle video representing the position of the vehicle. For example, when the video acquisition unit 50 acquires the videos of the front, rear, left and right sides of the vehicle, the bird's-eye view video generator 51 generates a bird's-eye view video by performing viewpoint conversion on the videos of the front, rear, left and right sides and synthesizing the videos into a virtual vehicle video.

The landmark specifying unit 52 specifies a landmark. A landmark specified by the landmark specifying unit 52 is referred to as a specified landmark. In the example, it is possible to specify a landmark viewed from a vehicle window as a specified landmark. For example, a famous site, such as a beauty spot, or an eye-catcher may serve as a specified landmark. Various fixed objects that can serve as marks, including constructions, such as buildings and facilities, or natural things, such as mountains and rivers, serve as specified landmarks. Furthermore, landmarks serve as direction-indicated objects. The direction-indicated object is an object to be displayed as an icon on the bird's-eye view video, and displaying the icon on the bird's-eye view video enables indication of the direction from the vehicle and the positional relationship with the vehicle. As described below, direction-indicated objects are not limited to landmarks.

The landmark specifying unit 52 selects at least one of possible landmarks as a specified landmark. The possible landmarks may be set in advance on manufacturing or on shipping of the vehicle display device 10 or may be set by a driver after the shipping of the vehicle display device 10. The landmark specifying unit 52 is able to acquire the geographic information from the storage unit 3, or the like, and set, as a specified landmark, a landmark that the user selects from the possible landmarks contained in the geographic information displayed on the display unit 4 or a landmark that is selected by the user after entering a name. The specified landmark that is specified by the landmark specifying unit 52 is one whose corresponding icon is to be displayed on the display unit 4.

Furthermore, for example, the user may specify a category of possible landmarks. In that case, the landmark specifying unit 52 extracts possible landmarks relating to the category that is specified from the geographic information on the basis of the current position of the vehicle and causes the display unit 4 to display the possible landmarks and the user may select a specified landmark from the possible landmarks. In that case, the possible landmarks extracted by the landmark specifying unit 52 are ones viewed from the current position of the vehicle.

For example, as for tall buildings, ones at a distance smaller than 10 kilometers from the current position of the vehicle and, as for mountains, ones at a distance smaller than 100 kilometers from the current position of the vehicle may serve as specified landmarks. Furthermore, for example, ones at a given height or higher, such as, as for tall buildings, ones at a height of 150 meters or higher and, as for mountains, ones at an altitude of 2500 meters or higher, may serve as specified landmarks. What covered by the definition of mountains by Geospatial Information Authority of Japan may serve as specified landmarks. Even ones without height, such as lakes and ponds, may serve as specified landmarks.

The height of a landmark may be an altitude (absolute value) or a difference of elevation (relative value). When the vehicle is too close to the landmark, the landmark is sometimes not viewable from the windows of the vehicle. In that case, the icon need not be displayed. In this case, for example, it is preferable that the icon of another landmark is displayed. Information about the heights of the landmarks may be acquired from another device via a communication line.

The positional information acquisition unit 53 acquires positional information about the specified landmark from the landmark information 33. The direction specifying unit 54 specifies a direction of the specified landmark radially from the vehicle on the basis of the current position and the travel direction of the vehicle and the positional information about the specified landmark. The icon acquisition unit 55 acquires an icon of the specified landmark, which is specified by the landmark specifying unit 52. The icon acquisition unit 55 may acquire an icon corresponding to the specified landmark, which is an icon stored in the storage unit 3, or may acquire an icon corresponding to the specified landmark, which is an icon acquired from another device via the communication line.

The display controller 56 adds the icon representing the specified landmark to the bird's-eye view video in the position in the direction specified by the direction specifying unit 54 and outputs data to be displayed on the display unit 4.

Operations of Vehicle Display Device

Operations of the vehicle display device 10 configured as described above will be described. The imaging unit 1 images the surroundings of the vehicle while the vehicle is traveling and acquires videos. The vehicle information acquisition unit 2 acquires the current position of the vehicle and calculates the direction in which the vehicle travels. The bird's-eye view video generator 51 generates a bird's-eye view video based on the videos acquired by the video acquisition unit 50.

The landmark specifying unit 52 specifies a landmark as a specified landmark. The positional information acquisition unit 53 acquires the positional information about the specified landmark. The direction specifying unit 54 specifies the direction of the specified landmark on the basis of the current position and the travel direction of the vehicle and the positional information about the specified landmark. The icon acquisition unit 55 acquires an icon of the specified landmark, which is specified by the landmark specifying unit 52.

The display controller 56 outputs data obtained by adding the icon to the bird's-eye view video. The display unit 4 displays the data that the display controller 56 outputs. According to the above-described operations, the bird's-eye view video is displayed on the display unit 4.

Exemplary Display

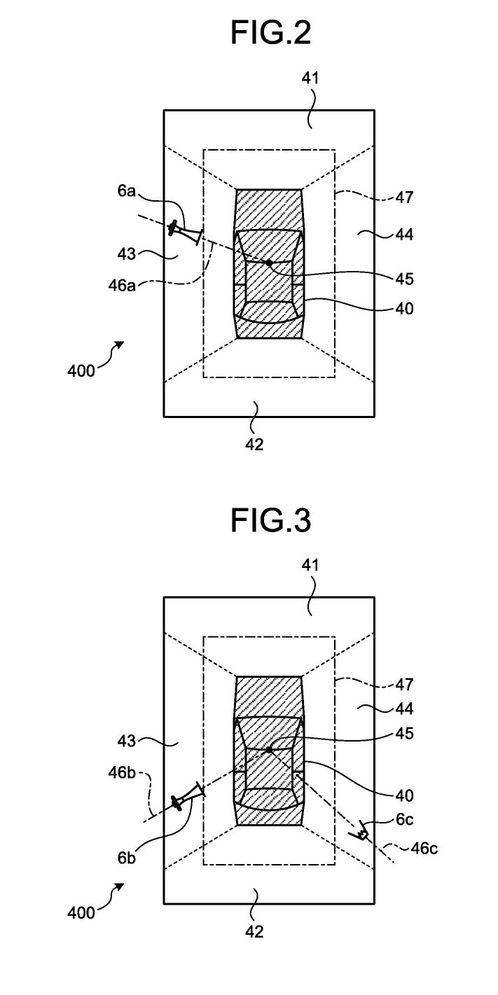

FIG. 2 is a diagram illustrating exemplary display of a bird's-eye view video that is performed by the display unit 4. As illustrated in FIG. 2, a bird's-eye view video 400 that is displayed by the display unit 4 includes a virtual vehicle diagram 40, a front-side video 41, a rear-side video 42, a left-side video 43 and a right-side video 44. In the bird's-eye view video 400, the front-side video 41, the rear-side video 42, the left-side video 43 and the right-side video 44 are positioned around the virtual vehicle diagram 40. In the bird's-eye view video 400, the front-side video 41 is arranged in a position corresponding to the front direction with respect to the virtual vehicle diagram 40, the rear-side video 42 is arranged in a position corresponding to the rear direction with respect to the virtual vehicle diagram 40, the left-side video 43 is arranged in a position corresponding to the left direction with respect to the virtual vehicle diagram 40, and the right-side video 44 is arranged in a position corresponding to the right direction with respect to the virtual vehicle diagram 40, respectively.

The bird's-eye view video 400 contains an icon 6a. The icon 6a is, in this example, an icon representing a tower that is a building. The icon 6a is arranged along a virtual line 46a that is one of virtual lines based on a center point 45 of the vehicle and radially extending distantly from the center point 45. The bird's-eye view video 400 represents that the radial direction from the vehicle in which the icon 6a is displayed is the direction in which the tower that is a landmark is positioned. For this reason, a person who is in the vehicle is able to intuitively understand the current orientation of the traveling vehicle and the direction of the landmark by checking the radial direction from the vehicle in which the icon 6a is displayed.

FIG. 3 is a diagram illustrating other exemplary display of a bird's-eye view video that is performed by the display unit 4. FIG. 3 illustrates a mode that is after the move of the vehicle from the state illustrated in FIG. 2. As illustrated in FIG. 3, the bird's-eye view video 400 displayed by the display unit 4 includes icons 6b and 6c. The icon 6b is an icon representing the same tower as that represented by the icon 6a represented in FIG. 2. In accordance with the move of the vehicle, the icon 6b is arranged along a virtual line 46b that is one of the virtual lines radially extending distantly from the center point 45 of the vehicle. The icon 6b is displayed at a position in a direction different from that in the case illustrated in FIG. 2.

The icon 6c is, in this example, an icon representing a mountain. The icon 6c is arranged along a virtual line 46c that is one of the virtual lines based on the center point 45 of the vehicle and radially extending distantly from the center point 45. The bird's-eye view video 400 of this example represents that the direction with respect to the vehicle in which the icon 6b is displayed is the direction in which the tower that is the specified landmark is positioned and that the direction in which the icon 6c is displayed is the direction in which the mountain serving as a specified landmark is positioned. Thus, a person who is in the vehicle is able to instinctively understand the current orientation of the traveling vehicle and the direction of the landmark by checking the radial directions from the vehicle in which the two icons 6b and 6c are displayed.

In FIGS. 2 and 3, the icons 6a, 6b and 6c may be displayed in positions close to the outer edge of the bird's-eye view video 400. For example, when a virtual line 47 representing middle positions between the virtual vehicle diagram 40 and the outer edge of the bird's-eye view video 400 is assumed, the icons 6a, 6b and 6c are displayed outside the virtual line 47 and inside the bird's-eye view video 400. For this reason, it is possible, in the bird's-eye view video 400, to display the icons 6a, 6b and 6c without putting any effect on the video of areas adjacent to the vehicle.

As illustrated in FIGS. 2 and 3, the vehicle display device 10 according to the first embodiment displays the specified landmarks by icons together with not only the video of the front side of the vehicle but also the video of the surroundings of the vehicle. By checking the icons of the specified landmarks contained in the bird's-eye view video, the person in the vehicle is able to check the directions of the specified landmarks with respect to the vehicle.

Display Method

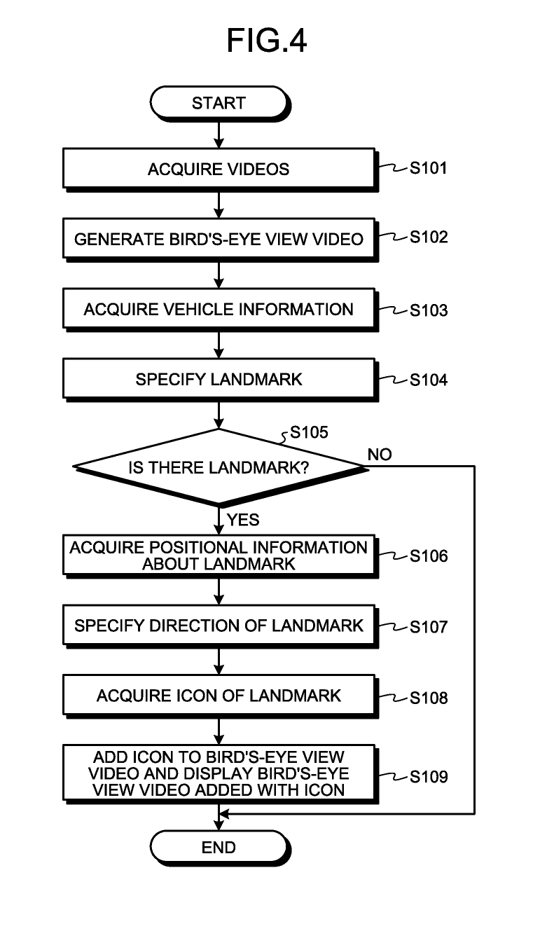

FIG. 4 is a flowchart illustrating an exemplary display method performed by the vehicle display device according to the first embodiment. According to FIG. 4, the video acquisition unit 50 acquires videos of the surroundings of the vehicle (step S101). On the basis of the acquired videos of the surroundings, the bird's-eye view video generator 51 generates a bird's-eye view video by performing viewpoint conversion to realize a view from above the vehicle and synthesizing a virtual vehicle video representing the position of the vehicle (step S102). The bird's-eye view video generator 51 further acquires, from the vehicle information acquisition unit 2, the vehicle information representing the current position of the vehicle and the direction in which the vehicle travels (step S103).

The landmark specifying unit 52 specifies a landmark as a specified landmark (step S104). The positional information acquisition unit 53 determines whether there is a specified landmark on which the process is to be performed (step S105). When it is determined that there is a specified landmark on which the process is to be performed (YES at step S105), the positional information acquisition unit 53 acquires positional information about the specified landmark (step S106).

The direction specifying unit 54 specifies the direction of the specified landmark radially from the vehicle on the basis of the current position and the travel direction of the vehicle and the positional information about the specified landmark (step S107). The icon acquisition unit 55 acquires an icon corresponding to the specified landmark (step S108).

The display controller 56 adds an icon to the bird's-eye view video and causes the display unit 4 to display the bird's-eye view video added with the icon (step S109). At step S105, when it is determined that there is not any specified landmark on which the process is to be performed (NO at step S105), the process ends.

According the above-described display method, the specified landmark is displayed with the icon together with not only the video of the front side of the vehicle but also the video of the surroundings of the vehicle. By checking the icon of the specified landmark, it is possible to check the direction of the specified landmark with respect to the vehicle.

### Second Embodiment

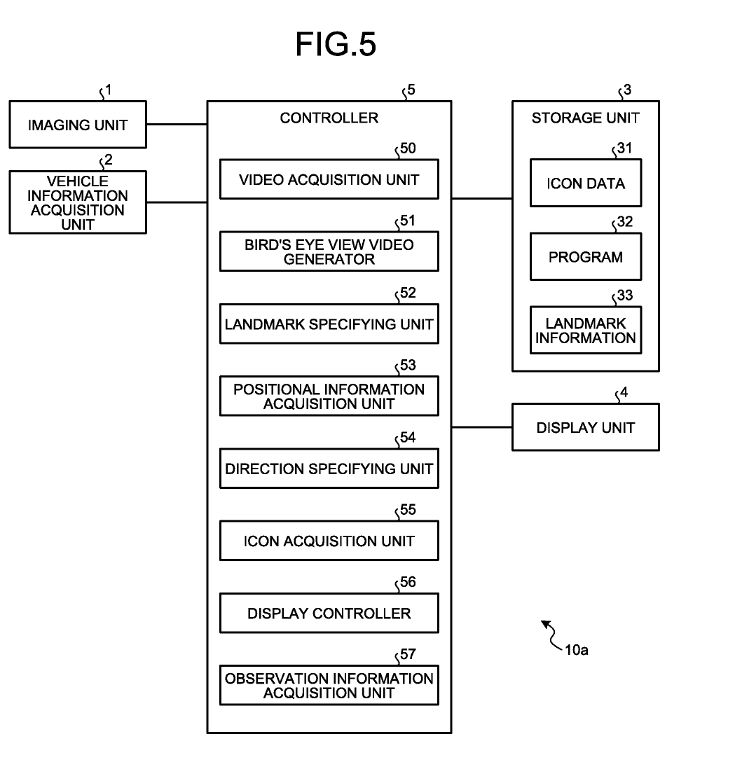

FIG. 5 is a diagram illustrating an exemplary functional configuration of a vehicle display device according to a second embodiment. As illustrated in FIG. 5, a vehicle display device 10a according to the second embodiment has a configuration realized by adding an observation information acquisition unit 57 to the vehicle display device 10 illustrated in FIG. 1.

The observation information acquisition unit 57 acquires observation information representing whether the specified landmark, which is specified by the landmark specifying unit 52, is observable from the current position of the vehicle. It suffices if the observation information is, for example, stored as geographic information of the navigation device. In that case, the observation information acquisition unit 57 acquires observation information from the navigation device. For example, the observation information may be stored in an external server or the storage unit 3. In that case, the observation information acquisition unit 57 may acquire observation information from another device via a communication line.

The observation information acquisition unit 57 checks observability on the basis of the acquired observation information. The observation information acquisition unit 57 may check observability by acquiring the observation information at every given time or at every given travel distance. The observation information acquisition unit 57 may check observability at every 30 seconds or check observability at every travel distance of the vehicle of 100 meters. When the specified landmark is observable according to the observation information, the display controller 56 adds an icon representing the specified landmark to the bird's-eye view video. When the specified landmark is not observable according to the observation information, the display controller 56 does not add the icon representing the specified landmark to the bird's-eye view video.

To check observability, users may post word-of-mouth information about observation on whether the specified landmark is observable from the position and the word-of-mouth information may be acquired to determine whether the specified landmark is viewable. A function of transmitting, as word-of-mouth information, information on observability of the specified landmark with respect to the position of the vehicle by operating the icon of the specified landmark displayed on the display unit 4 may be implemented.

The configurations of other components of the vehicle display device 10a are basically the same as those of the vehicle display device 10 described with reference to FIG. 1. Exemplary display is also the same as that of the vehicle display device 10 described with reference to FIG. 1.

Operations of Vehicle Display Device

Operations of the vehicle display device 10a configured as described above will be described. Operations of the vehicle display device 10a are basically the same as those of the vehicle display device 10 according to the above-described first embodiment. An aspect of the vehicle display device 10a different from the operations of the vehicle display device 10 is that the observation information acquisition unit 57 acquires the observation information and, on the basis of the observation information, determines whether the specified landmark is observable from the current position of the vehicle.

When the observation information acquisition unit 57 determines that the specified landmark is observable from the current position of the vehicle, as in the case of the operations of the vehicle display device 10 according to the first embodiment, the direction specifying unit 54 specifies the direction of the specified landmark and the icon acquisition unit 55 acquires an icon corresponding to the specified landmark. When the observation information acquisition unit 57 determines that it is not possible to observe the specified landmark from the current position of the vehicle, an icon corresponding to the specified landmark is not acquired and another specified landmark serves as a subject of the process.

According to the above-described operations, as an icon corresponding to the specified landmark is acquired only when it is determined that the specified landmark is observable, no unobservable specified landmark is added to the bird's-eye view video and the person in the vehicle more easily understands the current orientation of the traveling vehicle or the direction of the landmark.

In some cases, not the whole but part of a specified landmark is viewed from the vehicle. For example, a tower is behind another building and thus only the top half of the tower is viewed or a mountain is behind a building and thus only the right half of the mountain is viewed. In such a case, an icon may be displayed when the ratio of the viewed area to the whole specified landmark exceeds a given threshold. For example, when the viewed area of the specified landmark exceeds 50% of the whole specified landmark, an icon may be displayed. In this case, when the viewed area of the specified landmark does not exceed the threshold, no icon is displayed. Not displaying an icon of a landmark difficult to view and displaying an icon of a specified landmark that is viewed for sure enables the person in the vehicle to easily find the specified landmark and more easily understand the current orientation of the vehicle or the direction of the landmark.

Furthermore, for example, when not the whole but part of the specified landmark is viewed from the vehicle, an icon whose area is halved may be displayed. For example, when the top half of the tower is viewed, the top half of the icon may be displayed or only the right half or the left half may be displayed. A person in the vehicle may set an icon display mode by using the landmark specifying unit 52.

Display Method

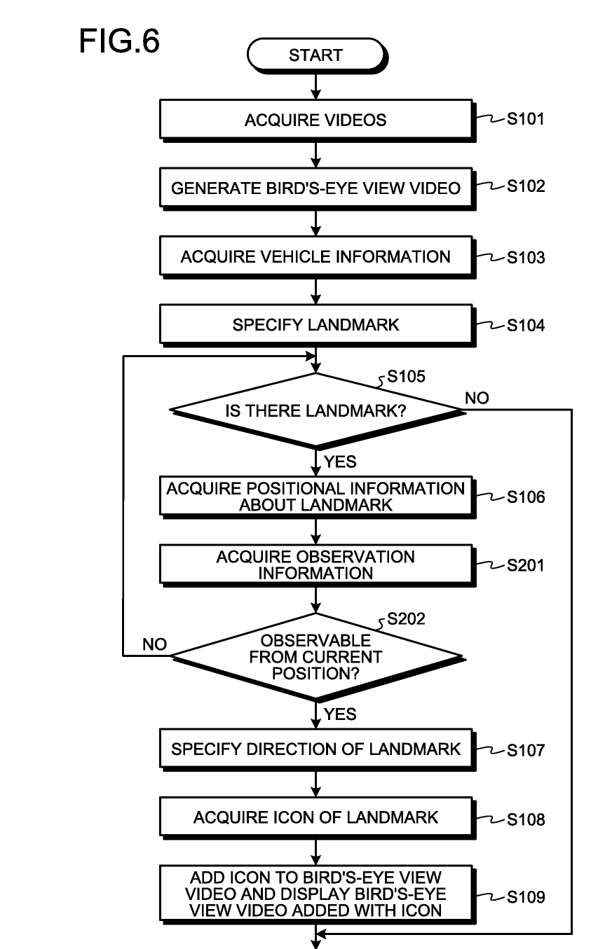

FIG. 6 is a flowchart illustrating an exemplary display method performed by the vehicle display device according to the second embodiment of the present invention. As illustrated in FIG. 6, the display method according to the second embodiment is realized by adding step S201 and S202 to the display method according to the first embodiment described with reference to FIG. 4.

After the positional information acquisition unit 53 acquires the positional information about the specified landmark at step S106, the observation information acquisition unit 57 acquires observation information (step S201). On the basis of the acquired observation information, the observation information acquisition unit 57 determines whether the specified landmark is observable from the current position of the vehicle (step S202).

At step S202, when it is determined that the specified landmark is observable from the current position of the vehicle (YES at step S202), the process proceeds to step S107 where the direction specifying unit 54 specifies a direction of the specified landmark radially from the vehicle on the basis of the current position and the travel direction of the vehicle and the positional information about the specified landmark (step S107). At step S202, when it is determined that the specified landmark is not observable from the current position of the vehicle (NO at step S202), the process returns to step S105 where the positional information acquisition unit 53 determines whether there is a specified landmark on which the process is to be performed (step S105). Other steps in FIG. 6 are the same as those of the display method according to the first embodiment described with reference to FIG. 4.

In the embodiment, the observation information is acquired and, as the icon of the specified landmark is acquired only when it is determined that the specified landmark is observable, no unobservable specified landmark is added to the bird's-eye view video and the person in the vehicle more easily understand the current orientation of the traveling vehicle or the direction of the landmark.

Display Program

In the first and second embodiments, each component of the controller 5 of the vehicle display device 10 or 10a is implemented by a CPU executing a program. The program may be loaded from the storage unit 3 into the controller 5 or may be loaded from another device into the controller 5 via a communication line. Each function of the vehicle display device may be implemented by causing the program to run in an information processing device, such as a tablet device, a smartphone or a laptop personal computer.

The program is a display program that causes a computer that operates as a vehicle display device to function as a unit configured to generate a bird's-eye view video obtained by performing viewpoint conversion on videos of surroundings of a vehicle to realize a view from above the vehicle and synthesizing a virtual vehicle video representing a position of the vehicle; a unit configured to specify a landmark as a specified landmark; a unit configured to acquire positional information about the specified landmark; a unit configured to acquire a current position and a travel direction of the vehicle; a unit configured to, on the basis of the current position, the travel direction and the positional information about the specified landmark, specify a direction of the specified landmark radially from the vehicle; and a unit configured to add an icon representing the specified landmark to the bird's-eye view video in the specified direction and displays the bird's-eye view video added with the icon.

Modification 1

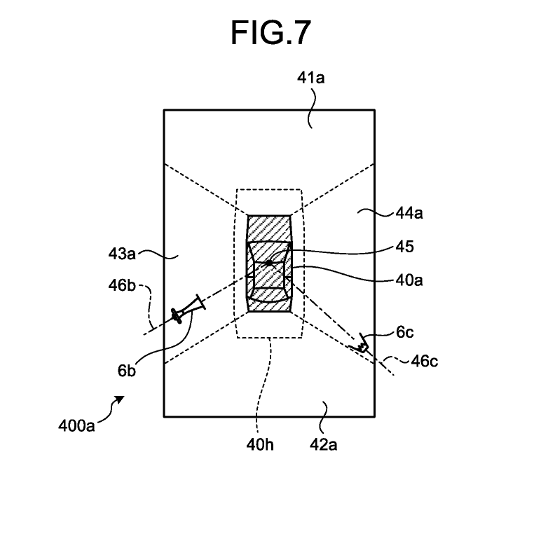

The virtual vehicle diagram may be displayed small. FIG. 7 is a diagram illustrating Modification 1 of the bird's-eye view video. A bird's-eye view video 400a of the example includes a virtual vehicle diagram 40a, a front-side video 41a, a rear-side video 42a, a left-side video 43a and a right-side video 44a.

In FIG. 7, the size of the virtual vehicle diagram 40 in the exemplary display described with reference to FIGS. 2 and 3 is represented by a dotted line 40h. In the example, the display controller 56 outputs data using the virtual vehicle diagram 40a in a size smaller than that of the virtual vehicle diagram 40 represented by the dotted line 40h. For this reason, in the bird's-eye view video 400a, even with the icons 6b and 6c added thereto, it is possible to keep a sufficient area to display the videos of the surroundings of the vehicle. Particularly when there are a lot of icon displays, it is possible to check the video of the surroundings of the vehicle without interference of the icons.

Modification 2

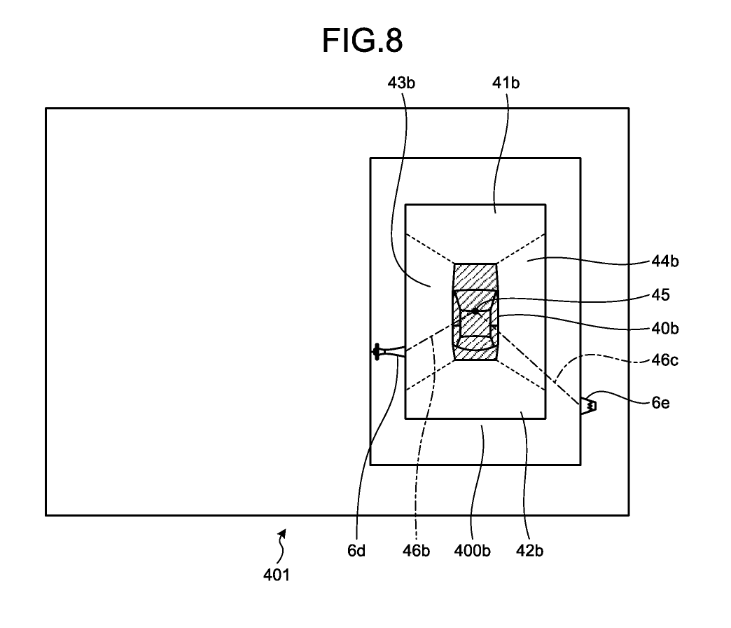

Icons of specified landmarks may be displayed outside the bird's-eye view video. FIG. 8 is a diagram illustrating Modification 2 of the bird's-eye view video. The example represents the case where a monitor, such as a monitor of a navigation device, having a display area to display, in addition to the bird's-eye view video, other information is used as the display unit 4. A bird's-eye view video 400b of the example is displayed on the right in a landscape screen 401. The bird's-eye view video 400b includes a virtual vehicle diagram 40b, a front-side video 41b, a rear-side video 42b, a left-side video 43b and a right-side video 44b. Icons 6d and 6e are displayed in a display area outside the bird's-eye view video 400b. The icons 6d and 6e are displayed such that part of the icons 6d and 6e are adhered to the periphery of the bird's-eye view video 400b. The display controller 56 outputs data in which the icons 6d and 6e are added outside the bird's-eye view video 400b. For this reason, in the bird's-eye view video 400b, it is possible to sufficiently keep a sufficient area to display a video of the surroundings of the vehicle even with the icons 6d and 6e added to the bird's-eye view video 400b. Particularly, when there are a lot of icon displays, it is possible to check the video of the surroundings of the vehicle without interference of the icons.

Modification 3

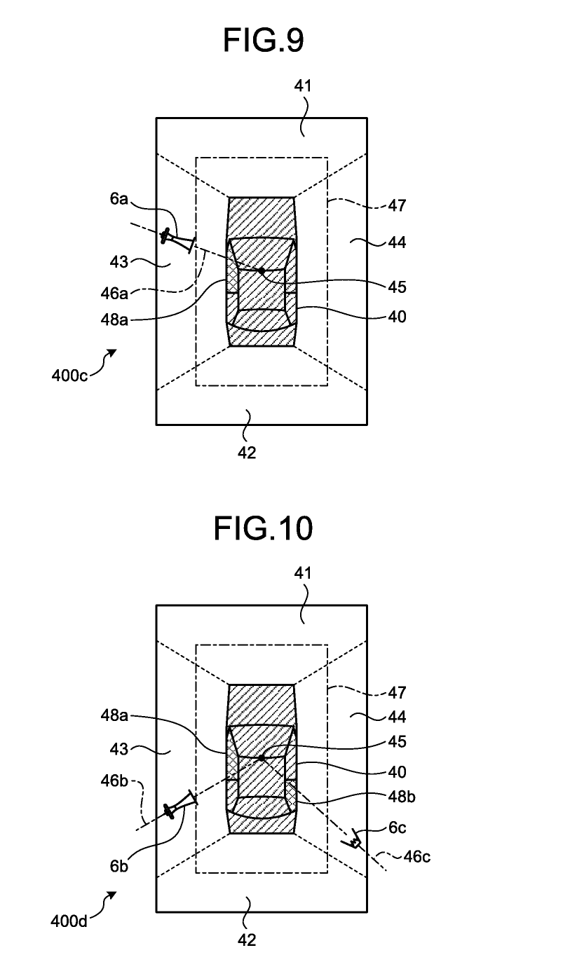

In the virtual vehicle diagram, a highlighted display may be added to a window in a direction in which an icon is displayed. FIGS. 9 and 10 are diagrams illustrating exemplary displays of the bird's-eye view video performed by the display unit 4. FIG. 9 is a diagram corresponding to FIG. 2 described above and FIG. 10 is a diagram corresponding to FIG. 3 described above. In a bird's-eye view video 400c illustrated in FIG. 9, a highlighted display is added to an area 48a corresponding to a window for which the icon 6a is displayed in the virtual vehicle diagram 40. In a bird's-eye view video 400d illustrated in FIG. 10, highlighted displays are added to the area 48a corresponding to a window for which the icon 6b is displayed and an area 48b corresponding a window for which the icon 6c is displayed in the virtual vehicle diagram 40. The display controller 56 outputs the data added with the highlighted displays.

The highlighted displays include, for example, a display in a color (for example, red) different from other parts, a display with a high brightness, and a blinking display in the bird's-eye view video 400c and the bird's-eye view video 400d. The highlighted displays serve as guides to the directions in which the specified landmarks are viewed (supposed to be viewed) and this clarifies that it is possible to check the landmark by viewing the outside from the window in the direction of the area 48a among the windows of the vehicle. Accordingly, a person in the vehicle finds the specified landmark easily. Particularly, when the vehicle display device 10 or 10a is used for the purpose of tourist guide or scenery navigation, such highlighted displays are great advantages.

Modification 4

The size of an icon may be changed and displayed according to the distance from the vehicle to a specified landmark. For example, an icon of a specified landmark distant from the vehicle may be displayed small and an icon of a specified landmark close to the vehicle may be displayed large. Controlling the size of an icon to be displayed enables a person in the vehicle to intuitively understand the distance from the vehicle to a specified landmark and easily find the specified landmark.

Modification 5

No icon may be displayed according to the speed of the vehicle. In other words, the speed of the vehicle may serve as a trigger to display an icon. For example, when the speed of the vehicle is low (for example, at a speed under 20 km/sec), no icon may be displayed and, when the speed of the vehicle is high, an icon may be displayed. When the speed of the vehicle is low, as it is assumed that the driver often uses the bird's-eye view video for parking, etc., refraining from displaying an icon allows the driver to focus on steering wheel operations.

Modification 6

Whether to display an icon may be determined according to the area in which the vehicle travels. For example, when the vehicle travels in an urban area, no icon may be displayed and, when the vehicle travels in a suburb area, an icon may be displayed. As there are a lot of structures serving as specified landmarks in an urban area, no icon may be displayed and, as marks are often necessary during traveling in a suburb area, icons may be displayed. On whether the area in which the vehicle travels is an urban area or a suburb area, it suffices if a boundary is set in advance and a determination may be made by comparing the boundary with the current position.

Modification 7

Icons may be displayed only when the road is one on which the vehicle travels for the first time (a road for which the number of times the vehicle travels is a given number or smaller). By storing the history of travels of the vehicle in the storage unit 3, or the like, and comparing the history with the current position of the vehicle, it is possible to determine whether there is no travel history for the road, i.e., whether the road is one on which the vehicle travels for the first time. When the road is one on which the vehicle has the first travel (one for which the number of times the vehicle travels is the given number or smaller), the number of icons to be displayed may be increased and, when the road is one on which the vehicle has the second or later travel (one for which the number of times the vehicle travels exceeds the given number), the number of icons to be displayed may be reduced.

Modification 8

The vehicle display device 10 or 10a may be integrated with a navigation device or may be a dedicated device independent of a navigation device. When the vehicle display device 10 or 10a is used together with a navigation device, the destination of navigation may be a specified landmark. In this case, a special icon representing the destination may be displayed on the display unit 4.

### Third Embodiment

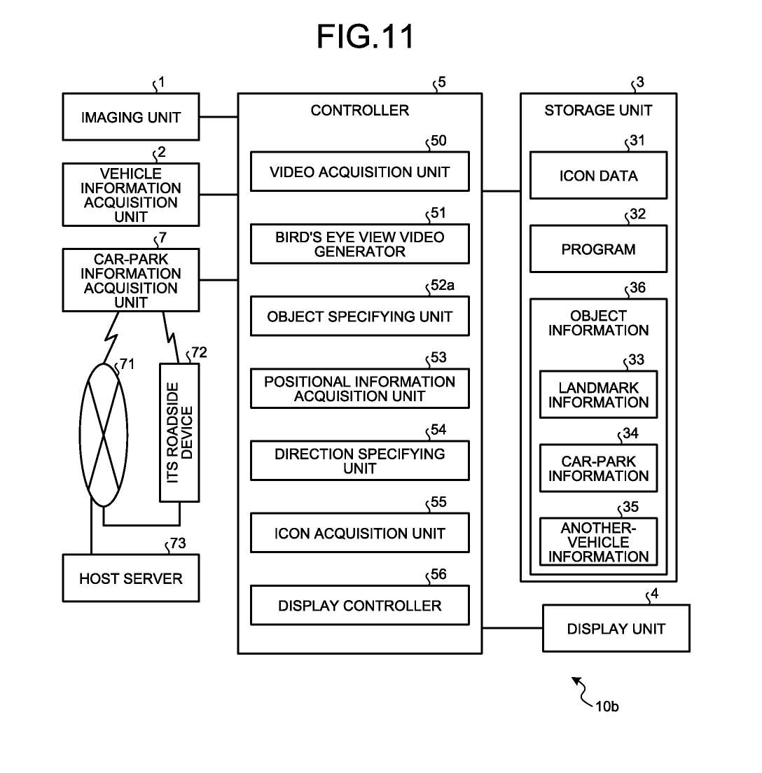

FIG. 11 is a diagram illustrating an exemplary functional configuration of a vehicle display device according to a third embodiment. As illustrated in FIG. 11, a vehicle display device 10b according to the third embodiment is realized by a function of the controller 5. The vehicle display device 10b includes the imaging unit 1, the vehicle information acquisition unit 2, the storage unit 3, the display unit 4, and a car-park information acquisition unit 7. The vehicle display device 10b is a device usable in a vehicle, and the vehicle display device 10b may be any one of a fixed one and a portable one. Unique aspects of the vehicle display device 10b will be focused on and described. Descriptions of the same components as those of the vehicle display device 10 will be omitted.

The storage unit 3 stores object information 36. The object information 36 includes the landmark information 33, car-park information 34 and another-vehicle information 35. The landmark information 33 contains positional information and height information about a landmark. The car-park information 34 contains exit information about a car park. The exit of the car park includes the exit gate of the car park. The another-vehicle information 35 contains positional information about another vehicle. The object information 36 may be stored in advance in the storage unit 3, and the vehicle display device 10b may refer to data in another device in a wireless or wired manner, acquire the data from another device, and store the data in the storage unit 3.

The car-park information acquisition unit 7 acquires car-park information corresponding to the current position of the vehicle on the basis of the current position information about the vehicle. The car-park information acquisition unit 7 acquires, for example, the car-park information that is stored in a host server 73 via an Internet line 71. The host server 73 acquires the car-park information from the car park of each area (not illustrated in the drawings) via the Internet line 71 and stores the car-park information. The car-park information acquisition unit 7 may acquire the car-park information from an ITS roadside device 72. The car-park information acquisition unit 7 may acquire the car-park information when the vehicle enters a car park. The acquired car-park information is stored as the car-park information 34 in the storage unit 3. The car-park information 34 may be stored in the storage unit 3 in advance. By acquiring the car-park information when the vehicle enters a car park, the car-park information acquisition unit 7 is able to acquire accurate car-park information even in a site like a temporary car park where the position of the exit changes frequently.

An object specifying unit 52a specifies a direction-indicated object to be displayed on the display unit 4. The direction-indicated object specified by the object specifying unit 52a serves as a specified object. In the third embodiment, the direction-indicated object includes the exit of each park. The object specifying unit 52a specifies, as a specified object, the exit of the car park corresponding to the current position of the vehicle on the basis of the car-park information that is acquired by the car-park information acquisition unit 7.

The positional information acquisition unit 53 acquires the positional information about the vehicle on the basis of the geographic information and the vehicle information and determines the current position of the vehicle. Furthermore, when it is determined that the current positon of the vehicle is in the car park, the positional information acquisition unit 53 acquires the positional information about the exit of the car park corresponding to the current position of the vehicle.

Operations of Vehicle Display Device

Operations of the vehicle display device 10b will be described. The operations of the vehicle display device 10b are basically the same as those of the vehicle display device 10 according to the above-described first embodiment. An aspect of the vehicle display device 10b different from the operations of the vehicle display device 10 is that the car-park information acquisition unit 7 acquires car-park information and, on the basis of the car-park information, specifies the exit of a car park as a specified object.

When the vehicle is in a car park, the car-park information acquisition unit 7 acquires car-park information. The object specifying unit 52a specifies the exit of the car park as a specified object. When the vehicle is not in any car park, the car-park information acquisition unit 7 does not operate and the object specifying unit 52a specifies a landmark as a specified object.

As in the case of the operations of the vehicle display device 10 according to the first embodiment, the positional information acquisition unit 53 acquires positional information about the specified object, the direction specifying unit 54 specifies a direction of the specified object, and the icon acquisition unit 55 acquires an icon corresponding to the specified object.

According to the above-described operations, when the vehicle is in a car park, the object specifying unit 52a specifies the exit of the car park as a specified object and the icon acquisition unit 55 acquires an icon corresponding to the exit of the car park and thus no landmark outside the car park is displayed in the car park on the display unit 4 and accordingly a person in the vehicle easily understands the travel direction of the traveling vehicle in the car park.

Exemplary Display

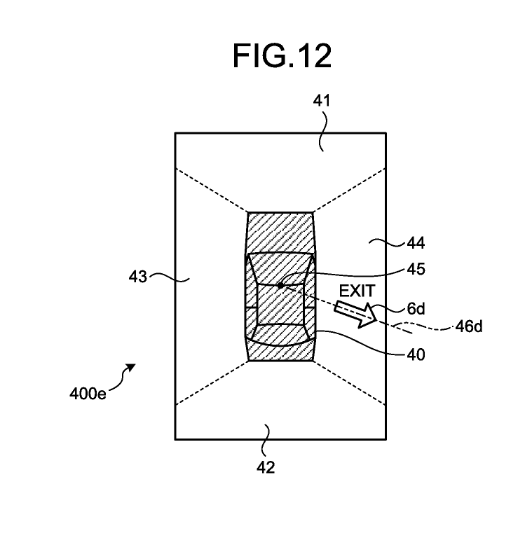

FIG. 12 is a diagram illustrating exemplary display of a bird's-eye view video that is performed by the display unit 4. A bird's-eye view video 400e illustrated in FIG. 12 includes the icon 6d. The icon 6d is, in this example, an icon representing the direction of the exit of the car park. The icon 6d is arranged along a virtual line 46d that is one of virtual lines based on the center point 45 of the vehicle and radially extending distantly from the center point 45. The bird's-eye view video 400e of this example represents that the direction with respect to the vehicle in which the icon 6d is displayed is the direction in which the exit of a car park that is a specified object is positioned. The icon 6d may be an icon that has a shape of an arrow representing the direction in which the exit of the car park is positioned. For this reason, a person in the vehicle is able to intuitively understand the current orientation of the traveling vehicle and the direction of the exit of the car park by checking the radial direction from the vehicle in which the icon 6d is displayed.

The configurations of other components of the bird's-eye view video 400e are the same as those of the bird's-eye view video 400 described with reference to FIG. 2.

Display Method

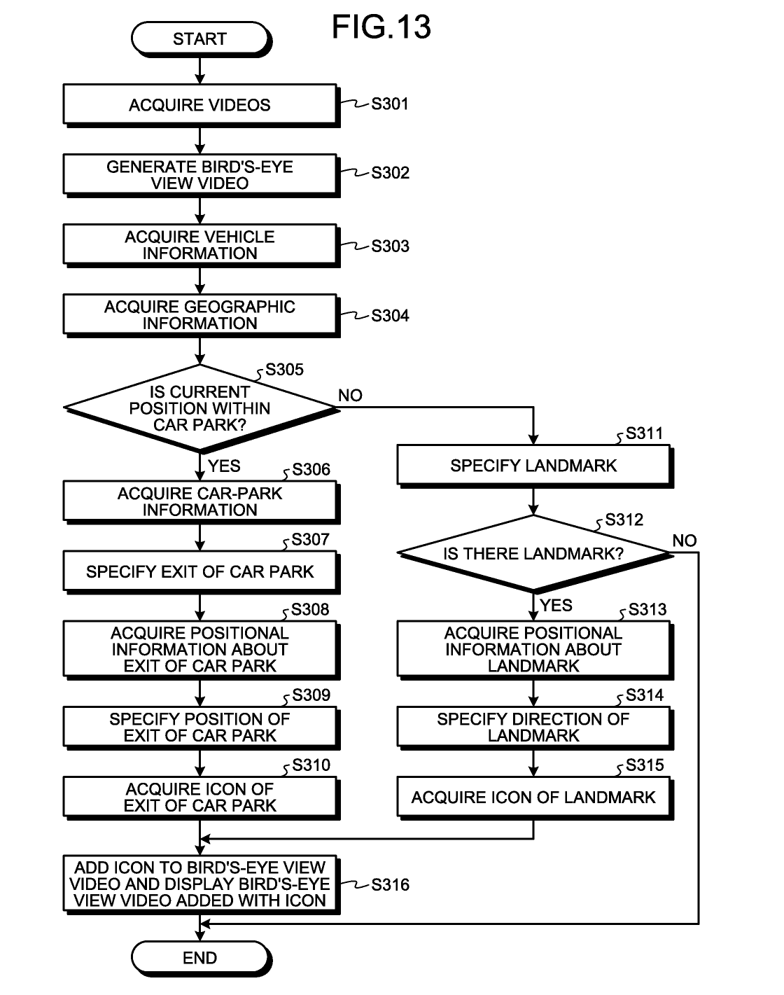

FIG. 13 is a flowchart illustrating an exemplary display method performed by the vehicle display device according to the third embodiment. According to FIG. 13, the video acquisition unit 50 acquires videos of the surroundings of the vehicle (step S301). On the basis of the acquired videos of the surroundings, the bird's-eye view video generator 51 generates a bird's-eye view video by performing viewpoint conversion to realize a view from above the vehicle and synthesizing a virtual vehicle video representing the position of the vehicle (step S302). The vehicle information acquisition unit 2 acquires vehicle information representing the current position of the vehicle and the direction in which the vehicle travels (step S303).

The positional information acquisition unit 53 then acquires the geographic information that is stored in the storage unit 3 (step S304). The car-park information acquisition unit 7 determines whether the vehicle is in a car park (step S305) and, when it is determined that the current position of the vehicle is within a car park (YES at step S305), acquires car-park information (step S306). The object specifying unit 52a specifies the exit gate of the car park as the exit of the car park that is the specified object (step S307) and the positional information acquisition unit 53 acquires positional information about the exit of the car park (step S308).

The direction specifying unit 54 specifies a direction of the exit of the car park radially from the vehicle on the basis of the current positon and the travel direction of the vehicle and the positional information about the exit of the car park (step S309). The icon acquisition unit 55 acquires an icon corresponding to the exit of the car park (step S310).

The display controller 56 adds the icon of the exit of the car park to the bird's-eye view video at a position in the direction specified by the direction specifying unit 54 and causes the display unit 4 to display the bird's-eye view video added with the icon (step S316).

At step S305, when it is determined that the current position of the vehicle is not within the car park (NO at step S305), the object specifying unit 52a specifies a landmark to be displayed on the display unit 4 as a specified object (step S311). The positional information acquisition unit 53 determines whether there is a landmark that is a specified object on which the process is to be performed (step S312) and, when it is determined that there is a landmark that is a specified object on which the process is to be performed (YES at step S312), acquires positional information about the landmark that is a specified object (step S313).

The direction specifying unit 54 specifies a direction of the landmark, which is the specified object, radially from the vehicle on the basis of the current position and the travel direction of the vehicle and the positional information about the landmark that is the specified object (step S314). The icon acquisition unit 55 acquires an icon corresponding to the landmark that is the specified object (step S315).

The display controller 56 adds the icon of the landmark that is the specified object to the bird's-eye view video and causes the display unit 4 to display the bird's-eye view video added with the icon (step S316). At step S312, when it is determined that there is not any landmark that is a specified object on which the process is to be performed (NO at step S312), the process ends.

According to the above-described method, when the vehicle is within a car park, the exit of the car park is displayed by using the icon together with not only the video of the front side of the vehicle but also the video of the surroundings of the vehicle. By checking the icon of the exit of the car park, it is possible to check the direction of the exit of the car park from the vehicle.

### Fourth Embodiment

The functional configuration of a vehicle display device according to a fourth embodiment is basically the same as that of the vehicle display device 10b illustrated in FIG. 11. In the fourth embodiment, the following descriptions will be provided for the case where a car park serving as a subject is multi-leveled.

In the fourth embodiment, when a car park serving as a subject is multi-leveled, car-park information that the car-park information acquisition unit 7 acquires contains altitude information about each level and exit information about each level.

In the fourth embodiment, a direction-indicated object that is specified by the object specifying unit 52a further includes the exit of the car park at each level in the car park corresponding to the current position of the vehicle. The object specifying unit 52a specifies, as a specified object, the exit of the car park with respect to the level corresponding to the current position of the vehicle on the basis of the level information about the car park that is acquired by the car-park information acquisition unit 7. When the car park is multi-leveled, the exit of the car park includes the exit gate of the car park, the entrance to the upper level and the entrance to the lower level at each level.

In the fourth embodiment, the positional information acquisition unit 53 acquires the latitude, the longitude and the altitude information as positional information about the vehicle and, on the basis of the positional information about the vehicle and the car-park information, specifies a level of the car park at which the vehicle is. The positional information acquisition unit 53 may specify the positional information about the vehicle by acquiring, with respect to each level, the positional information about the vehicle including the latitude, the longitude and the level from an internal GPS transmitter that is set in the car park. The positional information acquisition unit 53 acquires positional information about the exit of the car park with respect to the level corresponding to the current position of the vehicle in the car park having multiple levels.

Exemplary Display

Exemplary display of this example is the same as that of the bird's-eye view video described with referent to FIG. 12.

Display Method

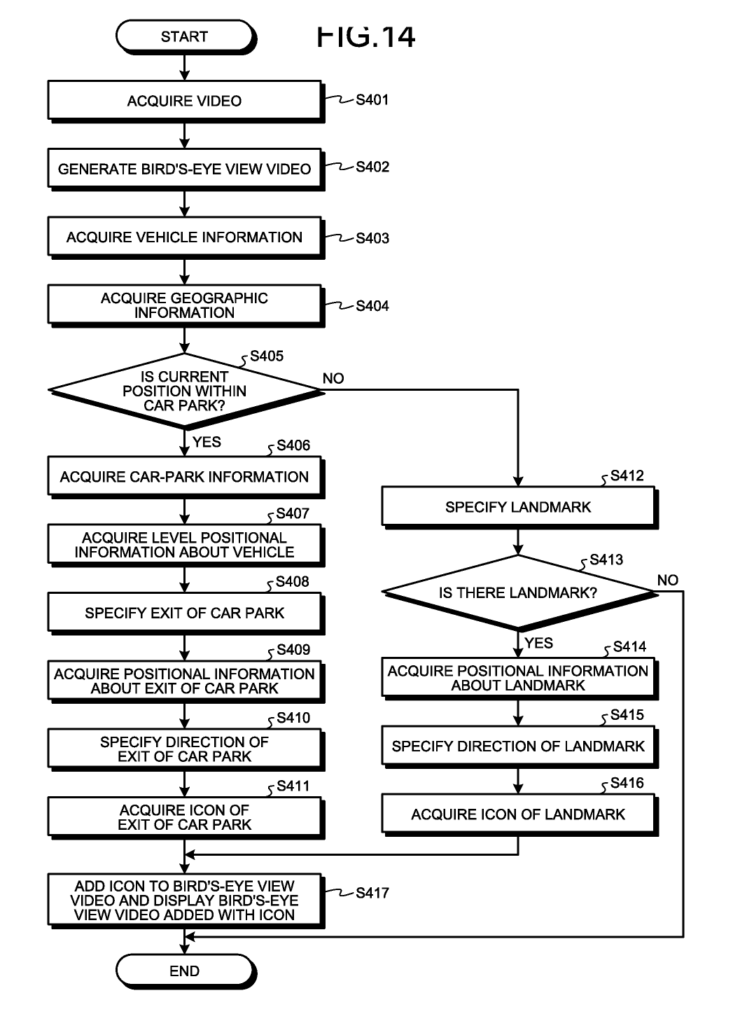

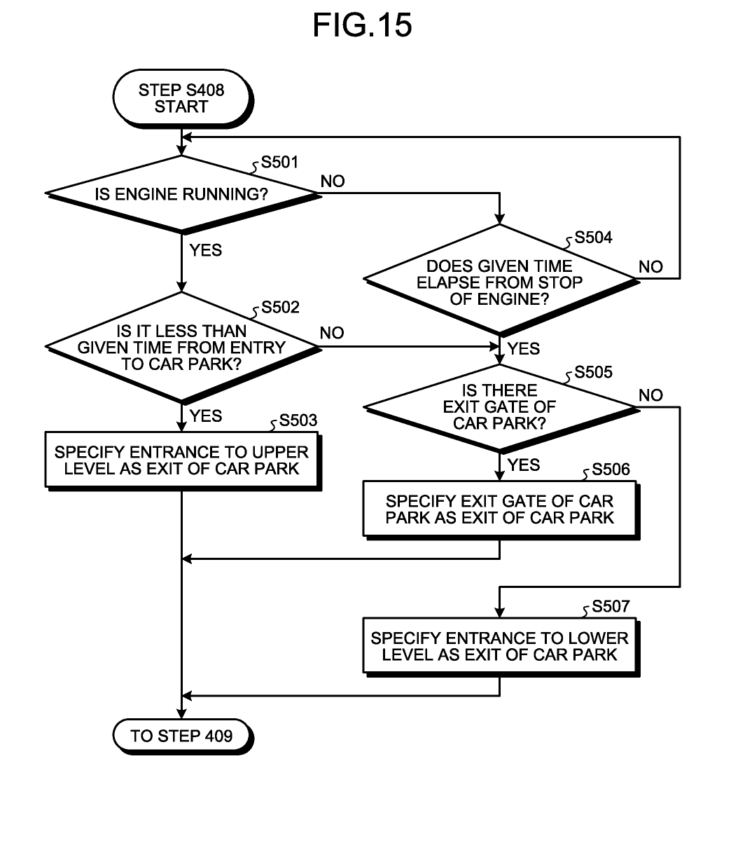

FIG. 14 is a flowchart illustrating an exemplary display method performed by the vehicle display device according to the forth embodiment of the present invention. FIG. 15 is a flowchart illustrating an exemplary method of specifying an exit of a park according to the fourth embodiment of the present invention at step S407 in the flowchart in FIG. 14.

According to FIG. 14, the video acquisition unit 50 acquires videos of the surroundings of the vehicle (step S401). On the basis of the acquired videos of the surroundings, the bird's-eye view video generator 51 generates a bird's-eye view video by performing viewpoint conversion to realize a view from above the vehicle and synthesizing a virtual vehicle video representing the position of the vehicle (step S402). The vehicle information acquisition unit 2 acquires vehicle information representing a current position of the vehicle and a direction in which the vehicle travels (step S403).

The positional information acquisition unit 53 then acquires the geographic information that is stored in the storage unit 3 (step S404). The car-park information acquisition unit 7 determines whether the vehicle is within a car park (step S405) and, when it is determined that the current position of the vehicle is within a car park (YES at step S405), acquires car-park information (step S406). The positional information acquisition unit 53 acquires car-park level positional information corresponding to the current position of the vehicle (step S407).

On the basis of the car-park information and the level positional information about the vehicle, which are acquired, the object specifying unit 52a specifies the exit of the car park with respect to the level corresponding to the current position of the vehicle, according to the flowchart representing the exemplary method of specifying an exit of a park illustrated in FIG. 15 (step S408).

According to FIG. 15, on the basis of the vehicle information that is acquired by the vehicle information acquisition unit 2, the object specifying unit 52a determines whether the engine of the vehicle is running (step S501) and, when it is determined that the engine of the vehicle is running (YES at step S501), goes to a step of determining whether it is less than a given time (for example, five minutes) from when the vehicle enters the car park (step S502). When it is determined that it is less than the given time from when the vehicle enters the car park (YES at step S502), the object specifying unit 52a specifies the entrance to the upper level as the exit of the car park that is the specified object (step S503) and the process goes to step S409 in the flowchart illustrated in FIG. 14.

At step S501, when it is determined that the engine of the vehicle is not running (the engine stops) (NO at step S501), the object specifying unit 52a determines whether a given time elapses from when the engine of the vehicle stops (step S504) and, when it is determined that the given time elapses from when the engine of the vehicle stops (YES at step S504), the object specifying unit 52a goes to a step (step S505) of determining whether there is an exit gate of the car park at the level of the car park corresponding to the current position of the vehicle (step S505).

At step S505, when it is determined that there is the exit gate of the car park (YES at step S505), the object specifying unit 52a specifies the exit gate of the car park as the exit of the car park that is the specified object (step S506) and the process goes to step S409 in the flowchart in FIG. 14.

At step S505, when it is determined that there is not the exit gate of the car park (NO at step S505), the object specifying unit 52a specifies the entrance to the lower level as the exit of the car park that is the specified object (step S507) and the process goes to step S409 in the flowchart in FIG. 14.

At step S502, when it is determined that the given time or more elapses from when the vehicle enters the car park (NO at step S502), the process goes to the step (step S505) of determining whether there is the exit gate of the car park at the level of the car park at which the vehicle is positioned (step S505).

At step S504, when it is determined that the given time does not elapse from when the engine of the vehicle stops (NO at step S504), the process returns to step S501.

According to FIG. 14, the process goes to a step (step S409) at which the positional information acquisition unit 53 acquires positional information about the exit of the car park (step S409). The flow from step S409 to step S411 is the same as that from step S308 to step S310 illustrated in FIG. 13 and thus descriptions thereof will be omitted.

The display controller 56 adds an icon of the exit of the car park to the bird's-eye view video in the direction that is specified by the direction specifying unit 54 and causes the display unit 4 to display the bird's-eye view video added with the icon (step S417).

At step S405, when it is determined that the current position of the vehicle is not at the entrance of the car park (NO at step S405), the process goes to a step (step S412) at which the object specifying unit 52a specifies a landmark. As the flow from step S412 to step S416 is the same as the flow from step S311 to step S315 described in FIG. 13, descriptions thereof will be omitted.

The display controller 56 adds the icon of the landmark that is the specified object to the bird's-eye view video and causes the display unit 4 to display the bird's-eye view video added with the icon (step S417). At step S413, when it is determined that there is not any landmark that is as a specified object on which the process is to be performed (NO at step S413), the process ends.

When the level at which the vehicle is positioned is the top level, the object specifying unit 52a specifies the entrance to the lower level as the exit of the car park that is the specified object. In the fourth embodiment, the case where the exit of the car park, such as a multistorey car park on the ground, whose exit gate is at the bottom level and that extends to the upper levels has been described. In the case where the car-park information acquisition unit 7 acquires car-park information about a multi-leveled car park, such as an underground car park, whose exit gate is at the top level and that extends to the lower levels, by replacing “the entrance to the upper level” at step S503 to “the entrance to the lower level”, replacing “the entrance to the lower level” at step S507 to “the entrance to the upper level” and then executing the flow, the vehicle display device according to the fourth embodiment is able to display the bird's-eye view video on the display unit.

According to the above-described display method, when the vehicle is within the car park, the exit of the car park is displayed by using the icon together with not only the video of the front side of the vehicle but also the video of the surroundings of the vehicle. By checking the icon of the exit of the car park, it is possible to check the direction of the exit of the car park with respect to the vehicle.

### Modification of Fourth Embodiment

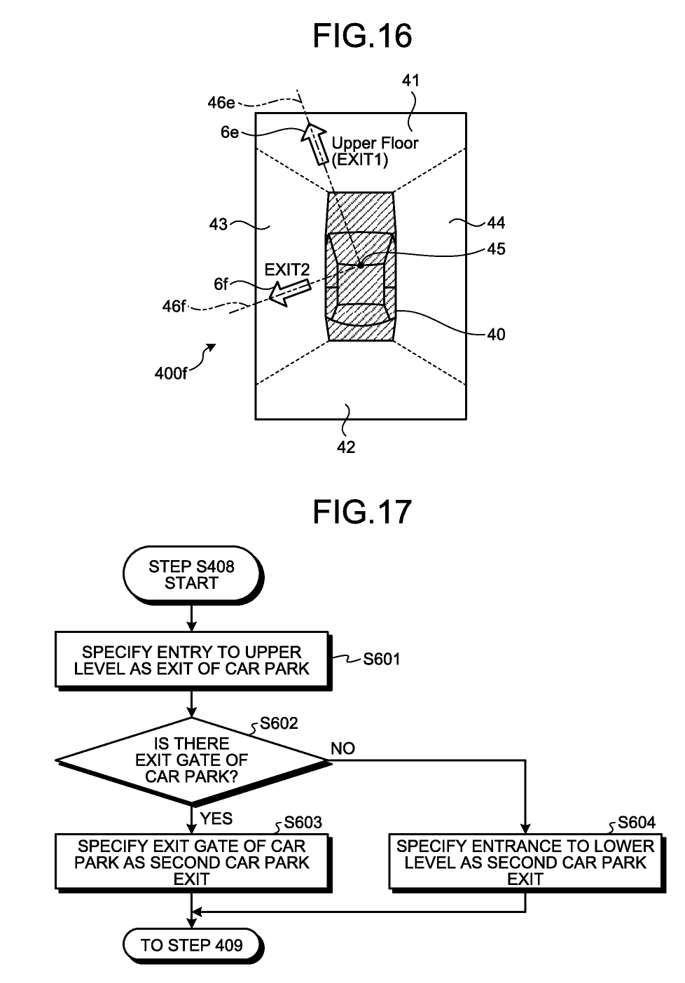

In the fourth embodiment of the present invention, multiple exits of the car park may be displayed as specified objects on the display unit 4. FIG. 16 is a diagram illustrating exemplary display of a bird's-eye view video that is performed by the display unit 4. In a modification of the fourth embodiment, a bird's-eye view video 400f displays two icons representing exits of a car park. Icons 6e and 6f are icons representing a first car park exit and a second car park exit. The entrance to the upper level may be specified as the first car park exit that is a specified object and the entrance to the lower level may be specified as the second car park exit that is a specified object.

Exemplary Display

FIG. 16 is a diagram illustrating a modification of the display of a bird's-eye view video performed by the display unit 4. The bird's-eye view video 400f illustrated in FIG. 16 includes the icons 6e and 6f. The icons 6e and 6f are arranged respectively in a superimposed manner on virtual lines 46e and 46f based on the center point 45 of the vehicle and radially extending distantly from the center point 45. By checking, with the bird's-eye view video 400f of this example, the directions with respect to the vehicle in which the icons 6e and 6f are displayed, it is possible to intuitively understand the current orientation of the traveling vehicle or the directions of the exits of the car park.

The configurations of other components of the bird's-eye view video 400f are the same as those of the bird's-eye view video 400 described with reference to FIG. 2.

Display Method

This is an exemplary modification of the method of specifying an exit of a car park according to the fourth embodiment at step S407 in the flowchart in FIG. 14. FIG. 17 is a flowchart illustrating the modification of the method of specifying an exit of a car park. In this example, the exit gate of a car park and the entrance to the upper level or the entrance to the lower level with respect to the level corresponding to the current position of the vehicle are specified and displayed as exits of the car park that are specified objects.

According to FIG. 17, the object specifying unit 52a specifies the entrance to the upper level as a first car-park exit (step S601). The object specifying unit 52a determines whether there is the exit gate of the car park at the level corresponding to the current positon of the vehicle (step S602) and, when it is determined that there is the exit gate of the car park at the level corresponding to the current positon of the vehicle (YES at step S602), specifies the exit gate of the car park as a second car-park exit (step S603) and the process goes to step S409 in the flowchart in FIG. 14. At step S602, when it is determined that there is not the exit gate of the car park at the level at which the vehicle is positioned (NO at step S602), the object specifying unit 52a specifies the entrance to the lower level as the second car-park exit (step S604) and the process goes to step S409 in the flowchart in FIG. 15.

When the level at which the vehicle is positioned is the top level, the object specifying unit 52a specifies only the entrance to the lower level as the exit of the car park. FIG. 17 illustrates the multi-leveled car park, such as a multistorey car park on the ground, that has the exit gate of the car park at the bottom level and that extends to the upper-levels. In the case where the car-park information acquisition unit 7 acquires car-park information about a multi-leveled car park, such as an underground car park, whose exit is at the top level and that extends to the lower levels, by replacing “the entrance to the upper level” at step S601 to “the entrance to the lower level”, replacing “the entrance to the lower level” at step S603 to “the entrance to the upper level” and then executing the flow, the vehicle display device according to this example is able to display the bird's-eye view video on the display unit.

According to the above-described display method, when the vehicle is within the car park, the vehicle display device 10b displays the first car-park exit and the second car-park exit by using the icons together with not only the video of the front side of the vehicle but also the video of the surroundings of the vehicle. The exit of the car park may be the exit gate of the car park, the entrance to the upper level, or the entrance to the lower level. By checking the icons of the exits of the car park, it is possible to check the directions of the exits of the car park with respect to the vehicle.

### Fifth Embodiment

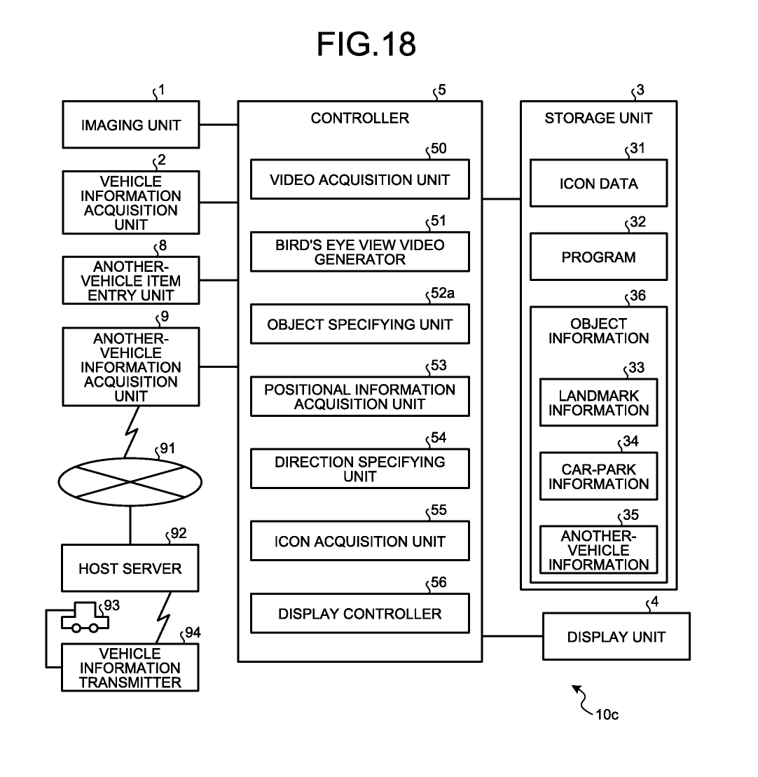

FIG. 18 is a diagram illustrating an exemplary functional configuration of a vehicle display device according to a fifth embodiment of the present invention. As illustrated in FIG. 18, a vehicle display device 10c according to the fifth embodiment is realized by a function implemented by the controller 5. The vehicle display device 10bc may include the imaging unit 1, the vehicle information acquisition unit 2, the storage unit 3, the display unit 4, an another-vehicle item entry unit 8, and an another-vehicle information acquisition unit 9. The vehicle display device 10c is a device usable in the vehicle. The vehicle display device 10c may be any one of a fixed one and a portable one. Another vehicle may be a vehicle toward the same destination as that of the vehicle.

In the fifth embodiment, the object information 36 is the same as the above-described object information 36 of the vehicle display device according to the third embodiment of the invention.

In the fifth embodiment, a direction-indicated object that is specified by the object specifying unit 52a includes a vehicle other than the vehicle. The object specifying unit 52a is able to specify another vehicle that is registered in advance as a specified object. For example, another vehicle toward the same destination may serve as a specified object.

In the fifth embodiment, the positional information acquisition unit 53 acquires positional information about the specified object from the object information 36. The positional information acquisition unit 53 acquires positional information about the other vehicle from the geographic information and another-vehicle information 35.

A person on the vehicle enters an another-vehicle registration item via the another-vehicle item entry unit 8 to register the item in the vehicle display device 10c. The another-vehicle information acquisition unit 9 acquires vehicle information that is stored in a host server 92 via an Internet line. The host server 92 acquires and stores the another-vehicle information from a vehicle information transmitter 94 that is set in another vehicle 93 that is registered in advance via an Internet line 791. The another-vehicle information contains the current position of the other vehicle. The another-vehicle information that the another-vehicle information acquisition unit 9 acquires is stored in the another-vehicle information 35 in the storage unit 3. The vehicle and the other vehicle are mutually able to refer to the sets of positional information via the Internet line.

The configurations of other components of the vehicle display device 10c are the same as those of the vehicle display device 10 described with reference to FIG. 1.

Operations of Vehicle Display Device

Operations of the vehicle display device 10c configured as described above will be described. Operations of the vehicle display device 10c are basically the same as those of the vehicle display device 10 according to the above-described first embodiment. An aspect of the vehicle display device 10c different from the operations of the vehicle display device 10 is that the another-vehicle registration item is registered in the vehicle display device 10c via the another-vehicle item entry unit 8 and the another-vehicle information acquisition unit 9 acquires the registered another-vehicle information and specifies the other vehicle as a specified object.

A person on the vehicle registers an another-vehicle registration item in the vehicle display device 10c via the another-vehicle item entry unit 8. The another-vehicle information acquisition unit 9 acquires the another-vehicle information about the vehicle that is registered in advance. The object specifying unit 52a specifies the other vehicle as the specified object to be displayed on the display unit 4.

As in the case of the operations of the vehicle display device 10 according to the first embodiment, the positional information acquisition unit 53 acquires positional information about the specified object, the direction specifying unit 54 specifies the direction of the specified object, and the icon acquisition unit 55 acquires an icon corresponding to the specified object.

Exemplary Display

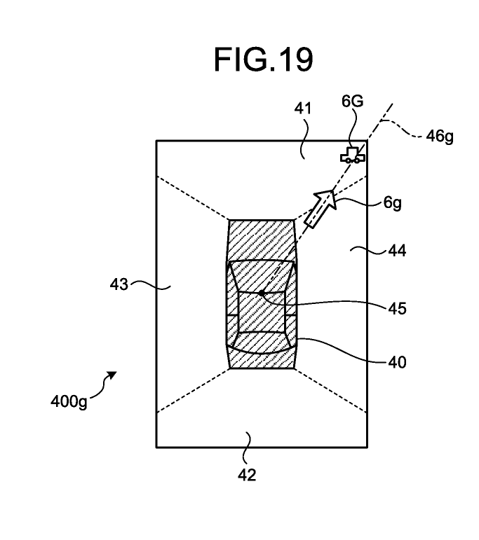

FIG. 19 is a diagram illustrating exemplary display of a bird's-eye view video that is performed by the display unit 4. A bird's-eye view video 400g illustrated in FIG. 19 includes an icon 6g and an icon 6G. In the fifth embodiment, the icon 6g is an icon of an arrow representing the direction in which the other vehicle is currently positioned and the icon 6G is an icon representing the other vehicle. The icon 6g of the arrow and the icon 6G of the other vehicle are arranged in a superimposed manner on a virtual line 46g that is one of virtual lines based on the center point 45 of the vehicle and radially extending distantly from the center point 45. The bird's-eye view video 400g of the example represents that the direction with respect to the vehicle in which the icon 6g of the arrow is displayed is the direction in which the other vehicle that is the specified object is positioned, and the icon 6G is displayed in front of the arrow. Accordingly, by checking the directions with respect to the vehicle in which the icon 6g of the arrow and the icon 6G of the vehicle are displayed, a person in the vehicle is able to intuitively understand the current orientation of the traveling vehicle or the direction of the other vehicle.

The configurations of other components of the bird's-eye view video 400g are the same as those of the bird's-eye view video 400 described with reference to FIG. 2.

Display Method

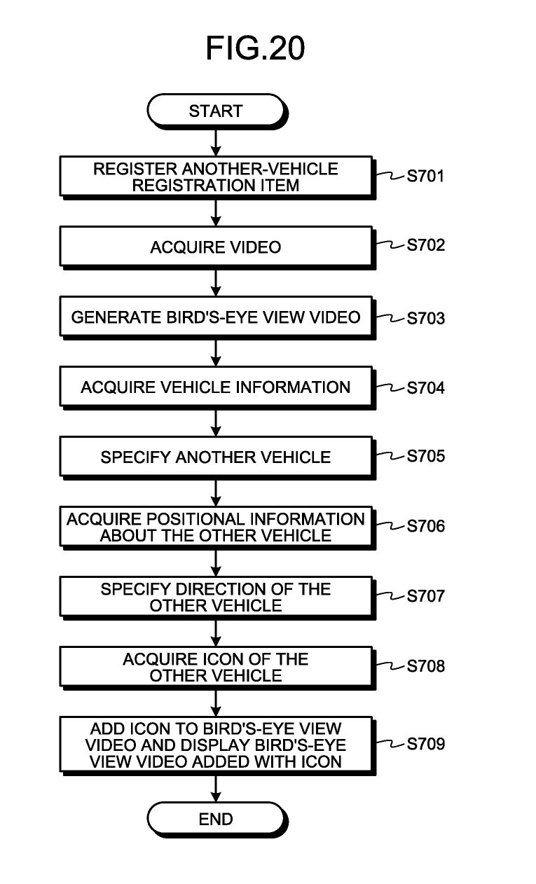

FIG. 20 is a flowchart illustrating an exemplary display method performed by the vehicle display device according to the fifth embodiment. According to FIG. 20, a person in the vehicle registers an another-vehicle registration item in the another-vehicle item entry unit 8 (step S701). The video acquisition unit 50 acquires videos of the surroundings of the vehicle (step S702). On the basis of the acquired videos of the surroundings, the bird's-eye view video generator 51 generates a bird's-eye view video by performing viewpoint conversion to realize a view from above the vehicle and synthesizing a virtual vehicle video representing the position of the vehicle (step S703). The vehicle information acquisition unit 2 acquires vehicle information representing the current position and the travel direction of the vehicle (step S704).

The object specifying unit 52a specifies another vehicle that is registered in advance as another vehicle that is a specified object (step S705) and the positional information acquisition unit 53 acquires positional information about the other vehicle from the another-vehicle information 35 that is acquired by the another-vehicle information acquisition unit 9 and stored in the storage unit 3 (step S706). The direction specifying unit 54 specifies a direction of the other vehicle radially from the vehicle on the basis of the current position and the travel direction of the vehicle and the positional information about the other vehicle (step S707). The icon acquisition unit 55 acquires an icon corresponding to the other vehicle that is registered in advance (step S708). The display controller 56 adds the icon to the bird's-eye view video and causes the display unit 4 to display the bird's-eye view video added with the icon (step S709).

According to the above-described display method, the vehicle display device 10c displays the other vehicle, which is registered in advance, by icons, together with the video of the surroundings of the vehicle. By checking the icon of the other vehicle, it is possible to check the direction of the other vehicle with respect to the vehicle.

### Modification of Fifth Embodiment

In the exemplary functional configuration of the vehicle display device according to the fifth embodiment of the present invention illustrated in FIG. 18, furthermore, the positional information acquisition unit 53 may calculate a direction in which the other vehicle travels on the basis of a position of the other vehicle acquired before and the current position of the other vehicle. The calculation of the travel direction performed by the positional information acquisition unit 53 may be replaced with calculation by the controller 5 from acquired current position information. Information of the travel direction of the other vehicle that is acquired by the positional information acquisition unit 53 is stored in the another-vehicle information 35 of the storage unit 3. In this example, the icon acquisition unit 55 may further reflect the travel direction in an icon 6h of the other vehicle. In this example, the display unit 4 may further add an icon of the other vehicle oriented in the travel direction to the bird's-eye view video.

Exemplary Display

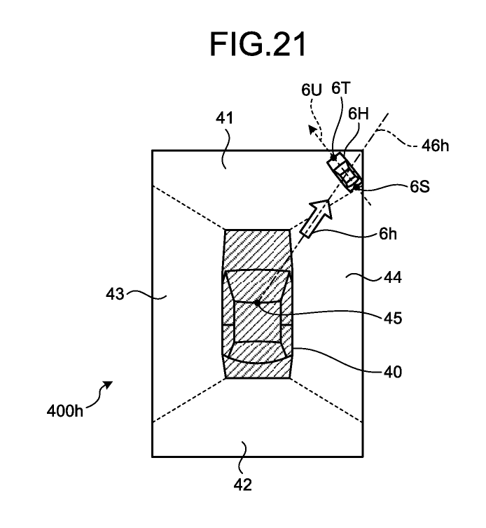

FIG. 21 is a diagram illustrating a modification of the display of a bird's-eye view video that is performed by the display unit 4. A bird's-eye view video 400h illustrated in FIG. 21 includes the icon 6h and an icon 6H. In the example, the icon 6h is an icon of an arrow representing the direction in which the other vehicle is currently positioned and the icon 6H is an icon of the other vehicle representing the direction in which the other vehicle travels. The icon 6h of the arrow and the icon 6H of the other vehicle are arranged along a virtual line 46h that is one of virtual lines based on the center point 45 of the vehicle and radially extending distantly from the center point 45. The bird's-eye view video 400h of the example represents that the direction with respect to the vehicle in which the icon 6h of the arrow is displayed is the direction in which the other vehicle that is the specified object is positioned, and the icon 6H of the other vehicle representing the travel direction is displayed in front of the arrow. The icon 6H of the other vehicle is arranged such that the icon 6H overlaps a virtual line 6U representing the travel direction of the other vehicle from a rear part 6S of the icon 6H to a front part 6T.

The configurations of other components of the bird's-eye view video 400h are the same as those of the bird's-eye view video 400 described with reference to FIG. 2.

Display Method

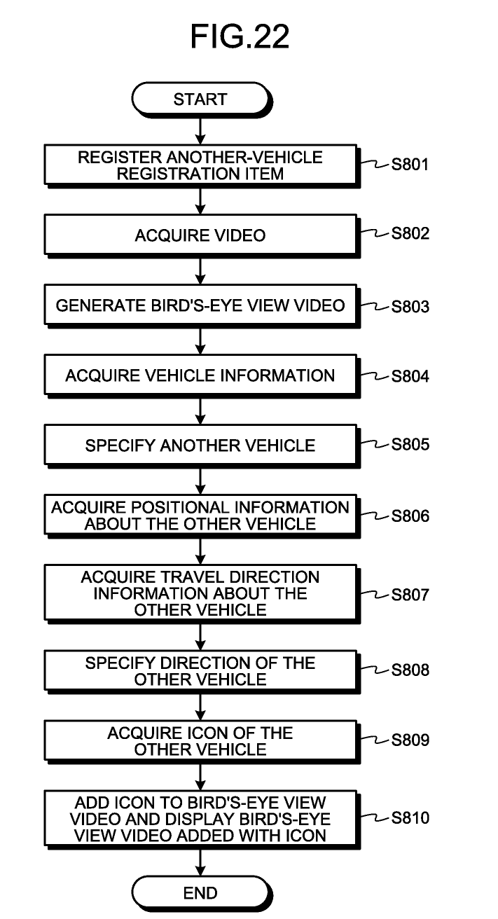

FIG. 22 is a flowchart illustrating an exemplary display method performed by the vehicle display device according to the modification of the fifth embodiment of the present invention. Steps S801 to S806 in the flowchart according to the modification are the same as steps S701 to S706 in the flowchart representing the exemplary display method performed by the vehicle display device according to the fifth embodiment. In the modification, after the positional information acquisition unit 53 acquires positional information about the other vehicle (step S806), the positional information acquisition unit 53 further acquires travel direction information about the other vehicle (step S807). Thereafter, as in the case of steps S707 to S709 of the display method according to the fifth embodiment, the direction specifying unit 54 specifies the direction of the other vehicle radially from the vehicle (step S808), the icon acquisition unit 55 acquires the icon 6H of the arrow representing the direction of the other vehicle and the icon 6h of the vehicle representing the travel direction of the other vehicle (step S809), and the display controller 56 adds the icon 6H and the icon 6h to the bird's-eye view video and causes the display unit 4 to display the bird's-eye view video added with the icons 6H and 6h (step S810).

According to the above-described display method, the vehicle display device 10c displays the direction of the other vehicle by using the icon having the shape of an arrow and displays the travel direction of the other vehicle by using the icon having the shape of a vehicle together with the video of the surroundings of the vehicle. By checking the icon of the arrow and the icon of the other vehicle, it is possible to check the direction of the other vehicle with respect to the vehicle and the travel direction of the other vehicle.

The above-described vehicle display device 10 or 10a adds a specified landmark as an icon to a bird's-eye view video and displays the bird's-eye view video added with the icon. When compared to a navigation device that displays only a video of the front side of the vehicle, the vehicle display device 10 or 10a displays specified landmarks around the vehicle by using icons. Accordingly, a person in the vehicle is able to easily understand not the actual direction but the relative direction (the positional relationship with the specified landmark). According to the vehicle display device 10 or 10a, it is possible to represent the position of the vehicle (orientation of the vehicle) easily to a driver, etc. Clearly representing the direction from the vehicle with a person therein in which a specified landmark serving as a subject is viewed enables the person in the vehicle to easily recognize the current position of the vehicle even when traveling in an unfamiliar area.

The above-described vehicle display device 10b adds the exit of a car park that is a specified object to a bird's-eye view video and displays the bird's-eye view video with the added icon. Only when the vehicle is within the car park, the vehicle display device 10b displays the exit of the car park by using the icon. Accordingly, a person in the vehicle is able to easily understand not the actual direction but the relative direction of the exit of the car park with respect to the vehicle. The vehicle display device 10b is able to represent the positon and the travel direction of the vehicle to the driver or the like. Representing clearly the exit of the car park serving as the subject from the vehicle with the person therein enables the person in the vehicle to easily recognize the current position of the vehicle in the car park even when the person uses the car park for the first time.

The above-described vehicle display device 10c or 10d adds the other vehicle serving as the specified object as the icon to the bird's-eye view video and displays the bird's-eye view video added with the icon. The above-described vehicle display device 10c or 10d displays the other vehicle around the vehicle by using the icon. Accordingly, a person in the vehicle is able to easily understand not the actual direction but the relative direction of the other vehicle with respect to the vehicle. According to the vehicle display device 10c or 10d, clearly representing the other vehicle that is registered in advance from the vehicle with a person therein enables the person in the vehicle to easily recognize the position of the other vehicle with respect to the vehicle even when the person travels in an unfamiliar area.

The present invention realizes an effect of enabling representation of a direction of a specified object serving as a subject from a vehicle with a person therein.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
a video acquisition unit configured to acquire videos obtained by imaging the surroundings of a vehicle;
a bird's-eye view video generator configured to generate a bird's-eye view video that is obtained by performing viewpoint conversion on the videos acquired by the video acquisition unit to realize a view from above the vehicle and synthesizing a virtual vehicle video representing a positon of the vehicle;
an object specifying unit configured to specify a direction-indicated object as a specified object;
a positional information acquisition unit configured to acquire positional information about the specified object;
a vehicle information acquisition unit configured to acquire a current position and a travel direction of the vehicle;
a direction specifying unit configured to specify a direction of the specified object radially from the vehicle on the basis of the current position, the travel direction, and the positional information about the specified object; and
a display controller configured to add an icon representing the specified object in the direction specified by the direction specifying unit to the bird's-eye view video and cause a display unit to display the bird's-eye view video added with the icon.

2. The vehicle display device according to claim 1, wherein the object specifying unit is configured to specify a landmark at a distance smaller than a given distance from the current position of the vehicle as the specified object on the basis of geographic information.

3. The vehicle display device according to claim 1, wherein the object specifying unit is configured to specify a landmark having a given height or higher as the specified object.

4. The vehicle display device according to claim 2, wherein the display controller is configured to add the icon representing the specified object such that the bottom of the icon is oriented to the virtual vehicle video and the top of the icon is positioned in a direction with respect to the virtual vehicle video in which the icon is distant radially from the virtual vehicle video.

5. The vehicle display device according to claim 2, further comprising an observation information acquisition unit configured to acquire observation information representing whether the landmark that is the specified object is observable on the basis of the current position of the vehicle, wherein
the display controller is configured to, when the landmark is observable according to the observation information, adds an icon representing the specified object.

6. The vehicle display device according to claim 1, further comprising a car-park information acquisition unit configured to acquire car-park information corresponding to the current position of the vehicle on the basis of the current position information about the vehicle,
wherein the object specifying unit is configured to, on the basis of the car-park information acquired by the car-park information acquisition unit, specify an exit of a car park corresponding to the current position of the vehicle as the specified object, and
the positional information acquisition unit is configured to acquire positional information about the exit of the car park corresponding to the current position of the vehicle as the position of the specified object.

7. The vehicle display device according to claim 6, wherein
the car-park information that is acquired by the car-park information acquisition unit contains exit information about each level when the car park that is a subject is a multi-leveled,
the object specifying unit is configured to, on the basis of the level information about the car park that is acquired by the car-park information acquisition unit, specify the exit of the car park with respect to a level corresponding to the current position of the vehicle as the specified object, and
the positional information acquisition unit is configured to acquire, as the position of the specified object, the positional information about the exit of the car park with respect to the level corresponding to the current position of the vehicle.

8. The vehicle display device according to claim 1, wherein
the object specifying unit is configured to specify, as the specified object, another vehicle that is registered in advance, and
the positional information acquisition unit is configured to acquire positional information about the other vehicle.

9. The vehicle display device according to claim 8, wherein
the positional information acquisition unit is configured to acquire travel direction information in addition to the positional information about the other vehicle, and
the display unit is configured to add an icon oriented in the travel direction of the other vehicle to the bird's-eye view video in the direction that is specified by the direction specifying unit.

10. The vehicle display device according to claim 6, wherein the display controller is configured to add an icon representing a direction of the specified object such that the direction represented by the icon is in a direction in which the specified object is distant radially from the virtual vehicle video.

11. A display method comprising:
acquiring videos obtained by imaging the surroundings of a vehicle;
generating a bird's-eye view video that is obtained by performing viewpoint conversion on the acquired videos to realize a view from above the vehicle and synthesizing a virtual vehicle video representing a positon of the vehicle;
specifying a direction-indicated object as a specified object;
acquiring positional information about the specified object;
acquiring a current position and a travel direction of the vehicle;
specifying a direction of the specified object radially from the vehicle on the basis of the current position, the travel direction, and the positional information about the specified object; and
adding an icon representing the specified object in the specified direction to the bird's-eye view video and displaying the bird's-eye view video added with the icon.

12. A non-transitory computer readable recording medium storing therein a display program that causes a computer that operates as a vehicle display device to function as:
a unit configured to generate a bird's-eye view video that is obtained by performing viewpoint conversion on videos acquired by imaging surroundings of a vehicle to realize a view from above the vehicle and synthesizing a virtual vehicle video representing a positon of the vehicle;
a unit configured to specify a direction-indicated object as a specified object;
a unit configured to acquire positional information about the specified object;
a unit configured to acquire a current position and a travel direction of the vehicle;
a unit configured to specify a direction of the specified object radially from the vehicle on the basis of the current position, the travel direction, and the positional information about the specified object; and
a unit configured to add an icon representing the specified object in the specified direction to the bird's-eye view video and display the bird's-eye view video added with the icon.
